(19) United States
(12) Patent Application Publication
(10) Pub. No.: US 2015/0198236 A1
(43) Pub. Date: Jul. 16, 2015

(54) LOCK IN DRIVE MECHANISM FOR ASSEMBLING AN AUTOMATIC TRANSMISSION

(71) Applicant: FORD GLOBAL TECHNOLOGIES, LLC, DEARBORN, MI (US)

(72) Inventors: RICH REJ, PLYMOUTH, MI (US); KAREN SILER, COMMERCE TOWNSHIP, MI (US)

(73) Assignee: FORD GLOBAL TECHNOLOGIES, LLC, DEARBORN, MI (US)

(21) Appl. No.: 14/151,963

(22) Filed: Jan. 10, 2014

(51) Int. Cl. F16H 59/02; B25B 11/00

(52) U.S. Cl. CPC F16H 59/0278; B25B 11/00; F16H 2059/0282

(57) ABSTRACT

A mechanism for locking a shifter of an automatic transmission, in a drive position, prior to assembly of the transmission to an automotive vehicle. The mechanism includes a shifter carried in a shifter core. A locking aperture is formed in the shifter core adjacent the drive position of a shift lever and extending across the travel path of the shift lever. The mechanism includes a locking pin having an elongated portion that fits into the locking aperture, and a gripping portion to allow manual extraction of the mechanism. When inserted into the locking aperture, the locking pin blocks the shift lever from moving out of the drive position.

### TECHNICAL FIELD

Embodiments of the present disclosure generally relate to automatic transmission systems in vehicles, and, more specifically, to devices for positioning and installing of automatic transmission shifters.

### BACKGROUND

Many contemporary automobiles incorporate automatic transmissions. An automatic transmission (AT) automatically changes the gear ratio according to the speed and load of a vehicle, avoiding the need for the driver to manually shift a gear lever several times. Basically, most automatic transmission systems (AT systems) have a defined set of gear ratios, plus a parking pawl that locks the output shaft of transmission when the vehicle is parked. Instead of a clutch, a torque converter is generally used by automatic transmission systems, to manage the connection between the transmission system and the engine of the vehicle. Besides fully automatic transmissions, several other types of transmissions are available, such as continuously variable transmissions (CVT) and semi-automatic transmissions.

Predominantly, automatic transmission systems are hydraulically operated. Basic components may include a torque converter connected to the engine of the vehicle, and a set of planetary gears that facilitate conversion between different gear ratios within an available range. The torque converter connects the engine to the transmission system of the vehicle, and acts as a substitute the mechanical clutch that is used in manual transmission systems. The planetary gear set, generally being a compound planetary gear set, includes a set of bands and clutches actuated by hydraulic servos to provide the different forward gear ratios.

The gear shift operation within AT systems may be facilitated manually, through a shift lever coupled to the transmission system through a shifter cable. The shifter can be moved manually between parking, drive and neutral positions. In fully automatic transmission systems, the gear shift operation can be carried out through an electronic switch provided at a suitable position, such as steering wheel.

Safety issues are important during vehicle assembly operations, including mounting a transmission system. For systems that employ shifters, a problem can arise when coupling the shift lever to the shifter cable. The transmission generally has a shifter core that receives and positions the shifter detent, ensuring proper positioning of the shift lever. It can easily be understood that if the shifter does not indicate the setting of the actual transmission, a safety problem can result.

In certain cases, it may be possible to install the shifter incorrectly. Safety considerations dictate that every effort be made to provide failsafe systems to ensure correct installation.

### SUMMARY

The present disclosure provides an assembly to aid coupling and installation of a gear shift lever to an automatic transmission system of a vehicle.

According to one aspect, the present disclosure provides a mechanism for locking a shifter of an automatic transmission in a drive position, before assembling the transmission to the vehicle. A shift lever is carried in a shifter core. A locking aperture is formed in the shifter core, adjacent to the drive position of the shift lever. The mechanism includes a locking pin, which has an elongated portion and a gripping portion. The elongated portion is sized to fit into the locking aperture, while the gripping portion facilitates the mechanism to be pulled out manually. The locking pin blocks the shift lever from moving from the drive position, when being inserted into the locking aperture.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

FIG. 1 illustrates an exemplary shift lever assembly, configured to control an automatic transmission system of a vehicle.

FIG. 2 illustrates an exemplary device/assembly configured to aid shift lever installation for an automatic transmission system of a vehicle.

FIG. 3 depicts the device of FIG. 2, installed and positioned within a shifter core of a transmission gear box.

FIG. 4 depicts the device of FIG. 2, in a partially removed configuration.

FIG. 5 depicts the device of FIG. 2, in a completely removed configuration, after the shift lever has been installed over the transmission gear box.

### DETAILED DESCRIPTION

The following detailed description illustrates aspects of the disclosure and its implementation. This description should not be understood as defining or limiting the scope of the present disclosure, however, such definition or limitation being solely contained in the claims appended thereto. Although the best mode of carrying out the invention has been disclosed, those in the art would recognize that other embodiments for carrying out or practicing the invention are also possible.

Definitions: The following definitions will be used in this document:

Gear—A mechanism for transferring power from the engine of a vehicle to the drive wheels in which there is a specific ratio of rotations of the engine to rotations of the drive wheels.

Gear state—The information required by an automatic transmission system to implement a given gear ratio.

Selector Position—One of the several positions that can be assumed by a selector mechanism.

Shift lever: A device for facilitating gear shift operations for an automatic transmission system, positioning the transmission in either of a Drive Mode (D), Neutral Mode (N/C), Parking Mode (P) or Reverse Mode (R).

Selector Mechanism—A device to allow the driver to instruct the electronic control module to identify which gear the driver wishes the vehicle to use. Examples of a selector mechanism might be shift levers, shift buttons, voice operated commands or other selection technologies known in the art.

Shifter core—A cavity within the outer casing of the vehicle transmission gear box, for retaining a bottom portion of the shift lever.

Select Switch—A driver operated switch which causes the automatic transmission system to shift directly to the next higher/lower programmed gear choice.

Vehicle—A motorized transportation conveyance which can carry passengers or cargo. It includes passenger vehicles, trucks, buses and motorized mobile equipment. The engine can be gasoline powered, diesel powered, electric powered, hybrid or other powering mechanisms known in the art.

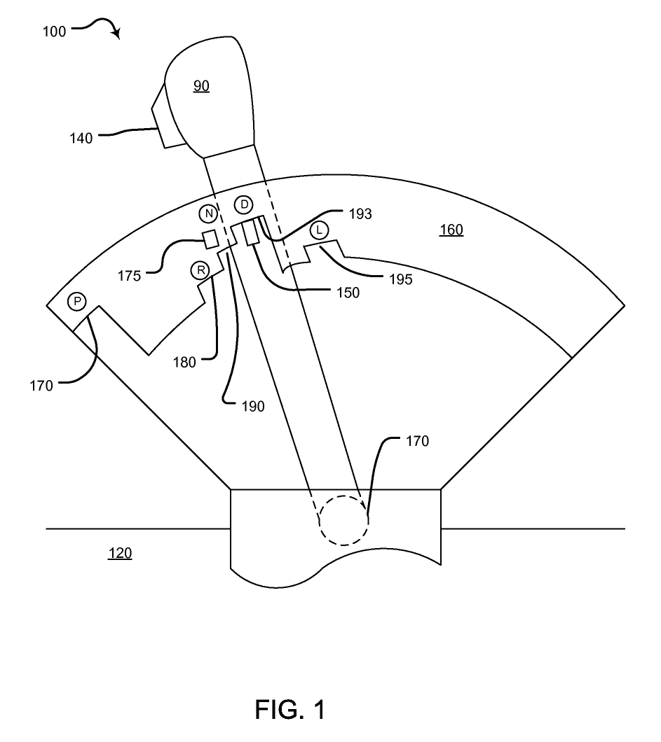

FIG. 1 illustrates a shifter assembly 100, mounted to control the automatic transmission of an automotive vehicle. Shifter assembly 100 includes the shift lever 70 that the driver employs to select a gear mode. Shift lever 70 is pivotally connected to a floor pan or base 120, mounted to rotate around pivot point 130. A knob 90, shaped to accommodate a user's hand, cap's the shift lever 70 and carries a release button 140. The driver can press that button to retract pawl pin 150 into the body of shift lever 70, employing suitable mechanical connection. Pawl pin 150 is adjustable to occupy a number of shift position indentations or detents formed in a shift gate 160. When pawl pin 150 engages a detent, the pawl locks the shift lever 70 in position.

Shift gate 160 includes detents to provide five shifter positions, each defined by a detent. From front to rear, the pattern describes the familiar P-R-N-D-L transmission mode pattern, with respective detents 170, 180, 190, 200 and 210. Thus, shifter 70 describes a travel path within shift gate 160, moving from detent to detent. A transmission cable (not shown) is attached to shifter 70, and as that element changes position, the cable also shifts position, in turn moving a mode selector on the automatic transmission body. Thus, the driver's moving shift lever 70 physically switches the automatic transmission from one mode, such as Park, to another mode, such as Drive.

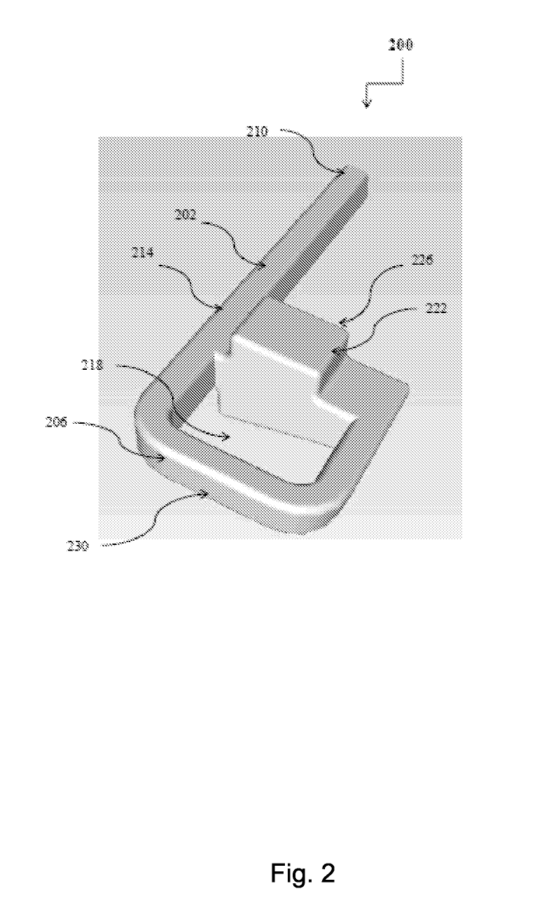

Locking aperture 175 extends through shift gate 160, located adjacent Drive detent 193. Locking aperture 175 extends across the travel path of shifter 70. As explained in connection with FIG. 2, below, locking aperture 175 permits shift lever 70, and thus the automatic transmission, to be locked in a forward gear mode (either Drive or Low).

FIG. 2 illustrates the locking pin 200 of the present disclosure, configured to retain the shift lever and the transmission in a common mode, thus, avoiding their misalignment during assembly.

As shown, the locking pin 200 includes an elongated portion 202, and a loop-shaped gripping portion 206. Preferably, the two members form a unitary structure.

The elongated portion 202 has a substantially linear structure, configured to be inserted into a shifter core provided in the outer casing of the transmission gear box. In the present embodiment, elongated portion 202 is specifically designed to be inserted into locking aperture in shift gate 160 (FIG. 1). As explained in greater detail below, the cross-section of elongated portion 202 is particularly adapted to fit into the shifter core. Here, that cross sectional profile is generally square, but other shapes could be employed. If it were considered advantageous, an irregular shape could be chosen, minimizing the possibility that the wrong object were inserted into the shifter core.

In the illustrated embodiment, the loop-structure has a rectangular shape; however, other alternative shapes can be contemplated in certain embodiments. Any suitable metal or metallic alloy can be used as the manufacturing material for the locking pin 200. In certain embodiments, the locking pin 200 may also be composed of a high strength plastic material.

A proximal end 214 of the locking pin 200 integrates with the gripping portion 206 perfectly. The distal end 210 is configured to be received substantially into the shifter core, to allow positioning of the locking pin 200 into the shifter core.

The gripping portion 206 has a relatively broadened rear support section 222 that engages the locking aperture, preventing its movement during shipping or installation. Specifically, the inner edge 226 of the section 222 directly in gauges locking aperture 175 to prevent the shift lever from moving out of the Drive detent 193. To affect that, the support structure is mechanically designed and sized accordingly.

The gripping portion 206 also acts as a pull-out handle for the locking pin 200. Once the installation is complete, the locking pin 200 can be extracted manually by pulling on the outer edge 230 of the gripping structure 206.

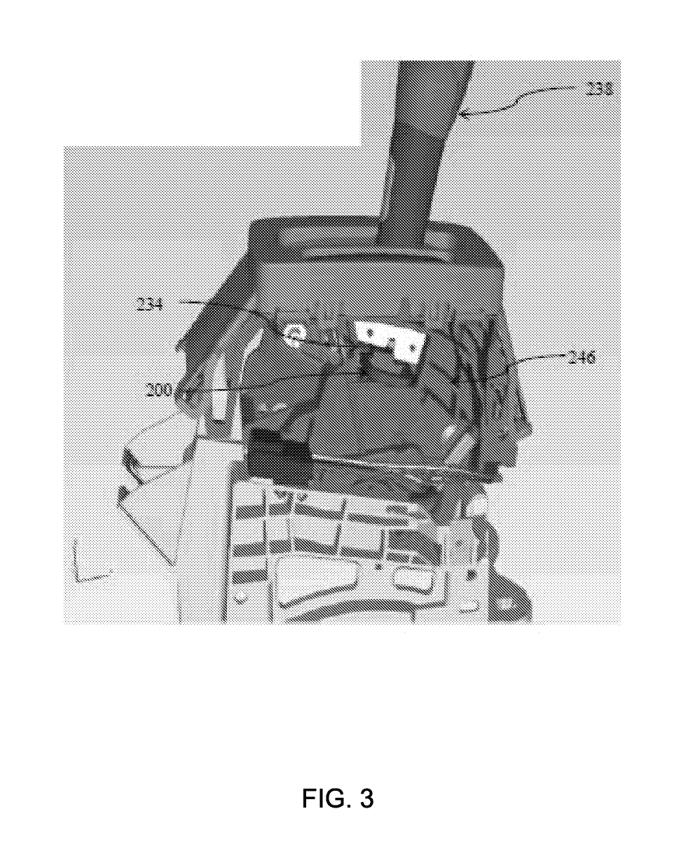

FIG. 3 illustrates the configuration where the locking pin 200 is fully positioned into the shifter core 234 of the transmission gear box 246 of a vehicle. As is seen more clearly here, a larger portion of the locking pin 200 is now residing into the shifter core 234, positioned close to the bottom edge of the shift 238. The shifter core 234 is a cavity within the outer casing of the transmission gear box. The locking pin 200 is dimensioned and sized to allow its positioning into the shifter core 234. In certain embodiments, the locking pin 200 may also snap fit into the shifter core.

In the illustrated state, the locking pin 200 completely blocks in a movement of the shift lever 238, and thus also preventing that element from misaligning with respect to the transmission 246. Both the shift lever 238 and the transmission 246 are, therefore, in a common mode in the illustrated figure, which is the transmission drive (D) mode.

During assembly, the transmission cable is attached to the shift lever 238, to permanently align the shift lever with respect to the transmission 246. Once the shifter cable is attached, the locking pin 200 can be pulled out of the shifter core 234, manually. Because the shift lever 70 has been prevented from moving out of the drive position, the safety issues have been addressed.

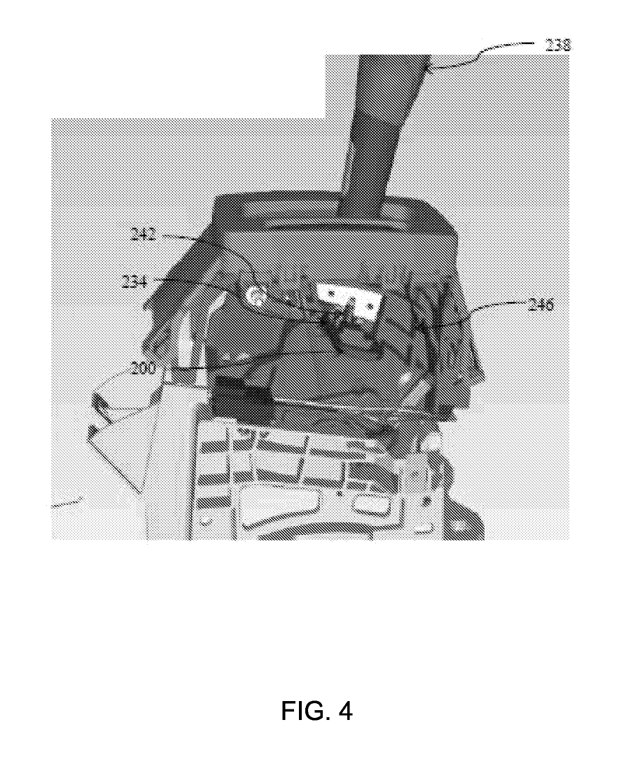

FIG. 4 depicts another configuration, after installation, where the locking pin 200 has been partially pulled out from the shifter core 234. Here, the shift lever detent 242 has been finally attached to the transmission, through the shifter cable, so that the shift lever 238 can remain in a fixed position without any further support.

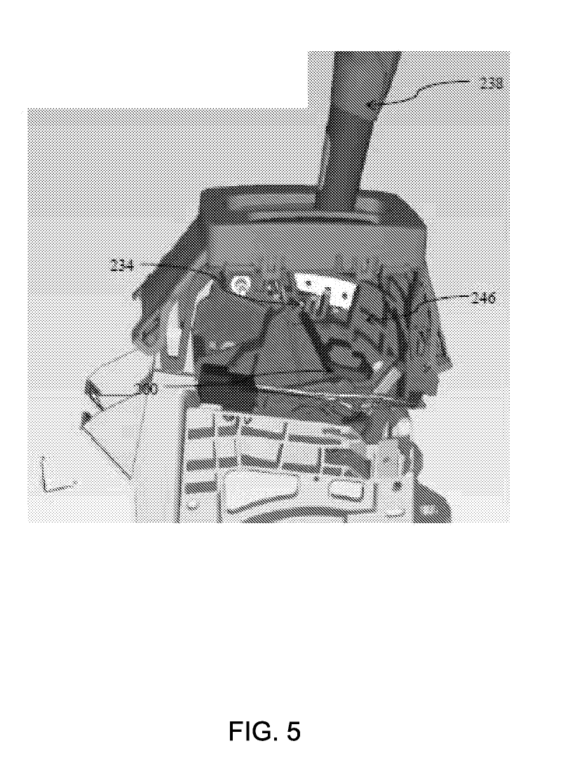

FIG. 5 depicts a subsequent configuration, where the locking pin 200 has been completely removed out from the shifter core. The shift lever attachment/installation is complete at this stage, and vehicle drive test can be carried out safely.

The design, shape and dimensions of the illustrated locking pin 200 are merely exemplary, and should not be construed as limiting the scope of the present disclosure. Variations in such parameters are possible in alternative embodiment.

Although the current invention has been described comprehensively, in considerable detail to cover the possible aspects and embodiments, those skilled in the art would recognize that other versions of the invention are also possible.

What is claimed is:

1. A mechanism for locking a shifter of an automatic transmission in a drive position prior to assembly in an automotive vehicle having a shift lever carried in a shifter core, the mechanism comprising:
a locking aperture formed in the shifter core adjacent the drive position of a shift lever, the locking aperture extending across a travel path of the shifter; and
a locking pin, including:
an elongated portion, adapted to fit into the locking aperture; and
a gripping portion adapted for facilitating manual extraction;
wherein the locking pin is positioned to block the travel path of the shift lever, preventing movement from the Drive position when the locking pin is inserted in the locking aperture.

2. The mechanism of claim 1, wherein the elongated portion has a substantially linear structure.

3. The mechanism of claim 1, wherein the gripping portion has a loop shaped rectangular structure.

4. The mechanism of claim 3, wherein a rear section of the gripping portion protrudes outwards, away from the shifter core, to facilitate manual extraction of the mechanism.
